(19) United States
(12) Patent Application Publication
(10) Pub. No.: US 2005/0135087 A1
(43) Pub. Date: Jun. 23, 2005

(54) Mirror with lighting system and sunvisor

(76) Inventors: Yasuya Mita, Kariya-shi (JP); Masayuki Harada, Kariya-shi (JP); Yoshio Sugiyama, Kariya-shi (JP); Mari Funada, Kariya-shi (JP); Masato Hieda, Kariya-shi (JP)

Correspondence Address: MORGAN & FINNEGAN, L.L.P., 3 World Financial Center, New York, NY, 10281-2101, US

(21) Appl. No.: 11/015,865

(22) Filed: Dec. 16, 2004

(30) Foreign Application Priority Data
Dec. 18, 2003 (JP) 2003-421407

(51) Int. Cl. F21V 33/00

(52) U.S. Cl. 362/135

(57) ABSTRACT

A mirror with lighting system includes a plurality of organic electroluminescent elements arranged adjacent to one another. A light emission switching device selects one of a full light emission state where all the organic electroluminescent elements emit light, a partial light emission state where some of the organic electroluminescent elements emit light, and a non-light emission state where all the organic electroluminescent elements do not emit light. Therefore, the mirror with lighting system has great light intensity without an external lighting when being used as a lighting system as compared to when being used as a mirror, and permits the entire surface to be used as a mirror when the environment is bright.

### BACKGROUND OF THE INVENTION

The present invention relates to a mirror with lighting system and a sunvisor.

A mirror with lighting system has been proposed that permits the mirror to be used in the dark without using a fluorescent light. In this mirror with lighting system, light emitting elements are located around the mirror. The light emitting elements are designed to emit light in the dark so that the mirror can be used without using external lighting. For example, the mirror with lighting system is disclosed in Japanese Laid-Open Patent Publications No. 2000-41807, No. 2002-329418, and No. 2003-217868. A mirror with lighting system that is used as a mirror at a bright place and as a lighting system at a dark place has also been proposed (for example, Japanese Laid-Open Patent Publication No. 2000-41807).

As the former mirror with lighting system, Japanese Laid-Open Patent Publication No. 2000-41807 discloses a mirror with lighting system (self-luminous mirror) 50, which is divided into a non-light emitting portion 51 and a light emitting portion 52, as shown in FIG. 10(a). According to the mirror with lighting system 50, the non-light emitting portion 51 can be used as a mirror while the light emitting portion 52 emits light. When the light emitting portion 52 is not emitting light, the non-light emitting portion 51 and the light emitting portion 52 are used as a mirror.

As for the latter mirror with lighting system, the above publication No. 2000-41807 discloses a mirror with lighting system 60 as shown in FIG. 10(b). Light emitting elements are formed on the entire surface of the mirror with lighting system 60. The entire surface of the mirror with lighting system 60 emits light when being used as the lighting system and the entire surface does not emit light when being used as the mirror.

However, according to the former mirror with lighting system 50, the peripheral portion of the mirror functions as a lighting portion when the power is on and other portion functions as a mirror. That is, the mirror with lighting system 50 only has the lighting portion at the periphery of the mirror and lacks the light intensity when being used as a night light.

The latter mirror with lighting system 60 only functions as a lighting system when the power is on and cannot be used as a mirror. The mirror with lighting system 60 serves only as a mirror when being used as a mirror, and does not serve as a lighting system for lighting up the face of the user. Therefore, the mirror with lighting system 60 cannot be used as a mirror in the dark.

### SUMMARY OF THE INVENTION

Accordingly, it is an objective of the present invention to provide a mirror with lighting system and a sunvisor. More specifically, the present invention pertains to a mirror with lighting system that can be used as a mirror in the dark without an external lighting, has great light intensity when being used as a lighting system as compared to when being used as a mirror, and permits the entire surface to be used as a mirror when the environment is bright.

To achieve the above-mentioned objective, the present invention provides a mirror with lighting system. The mirror includes a transparent substrate and an organic electroluminescent device formed on the transparent substrate. The organic electroluminescent device includes a plurality of organic electroluminescent elements arranged adjacent to one another. A light emission switching device selects one of a full light emission state where all the organic electroluminescent elements emit light, a partial light emission state where some of the organic electroluminescent elements emit light, and a non-light emission state where all the organic electroluminescent elements do not emit light. An entire surface of a light reflective portion functions as a mirror when the non-light emission state is selected.

Another aspect of the present invention provides a mirror with lighting system. The mirror includes a transparent substrate; a first electrode formed on the transparent substrate; an organic electroluminescent layer formed on the first electrode; and a second electrode formed on the organic electroluminescent layer. At least one of the first electrode and the second electrode has a plurality of electrode portions, which are discontinuous. A light emission switching device selects one of a full light emission state where portions of the organic electroluminescent layer corresponding to all the electrode portions emit light, a partial light emission state where portions of the organic electroluminescent layer corresponding to some of the electrode portions emit light, and a non-light emission state where the entire organic electroluminescent layer does not emit light. The mirror includes a light reflective portion.

Another aspect of the present invention provides a mirror with lighting system including a plurality of panels. Each panel includes a transparent substrate and an organic electroluminescent device located on the transparent substrate. The panels are arranged such that the end faces of the transparent substrates face one another. A light emission switching device selects one of a full light emission state where all the organic electroluminescent devices emit light, a partial light emission state where some of the organic electroluminescent devices emit light, and a non-light emission state where all the organic electroluminescent devices do not emit light. Wherein an entire surface of a light reflective portion functions as a mirror when the non-light emission state is selected.

Another aspect of the present invention provides a sunvisor of an automobile having a vanity mirror. The vanity mirror includes a transparent substrate and an organic electroluminescent device formed on the transparent substrate. The organic electroluminescent device includes a plurality of organic electroluminescent elements arranged adjacent to one another. The vanity mirror includes a light emission switching device for selecting one of a full light emission state, a partial light emission state, and a non-light emission state; and a light reflective portion.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a plan view illustrating the relationship between a vanity mirror and a sunvisor according to a first embodiment of the present invention;

FIG. 1(b) is a view illustrating a mirror with lighting system;

FIG. 2 is a cross-sectional view illustrating an organic EL element incorporated in the lighting system of FIG. l(b);

FIG. 3 is an enlarged cross-sectional view taken along line A-A of FIG. 1(b);

FIG. 4 is a view illustrating the position of organic EL elements according to a second embodiment of the present invention;

FIG. 5 is a schematic perspective view illustrating a third embodiment of the present invention;

FIG. 6 is a view illustrating the position of organic EL elements according to a fourth embodiment of the present invention;

FIG. 7 is a cross-sectional view illustrating a fifth embodiment of the present invention;

FIG. 8 is a cross-sectional view illustrating a sixth embodiment of the present invention;

FIG. 9 is a cross-sectional view illustrating a seventh embodiment of the present invention;

FIG. 10(a) is a plan view illustrating a prior art mirror with lighting system; and

FIG. 10(b) is a plan view illustrating another prior art mirror with lighting system.

### DETAILED DESCRIPTION OF THE PREFERRED EMBODIMENTS

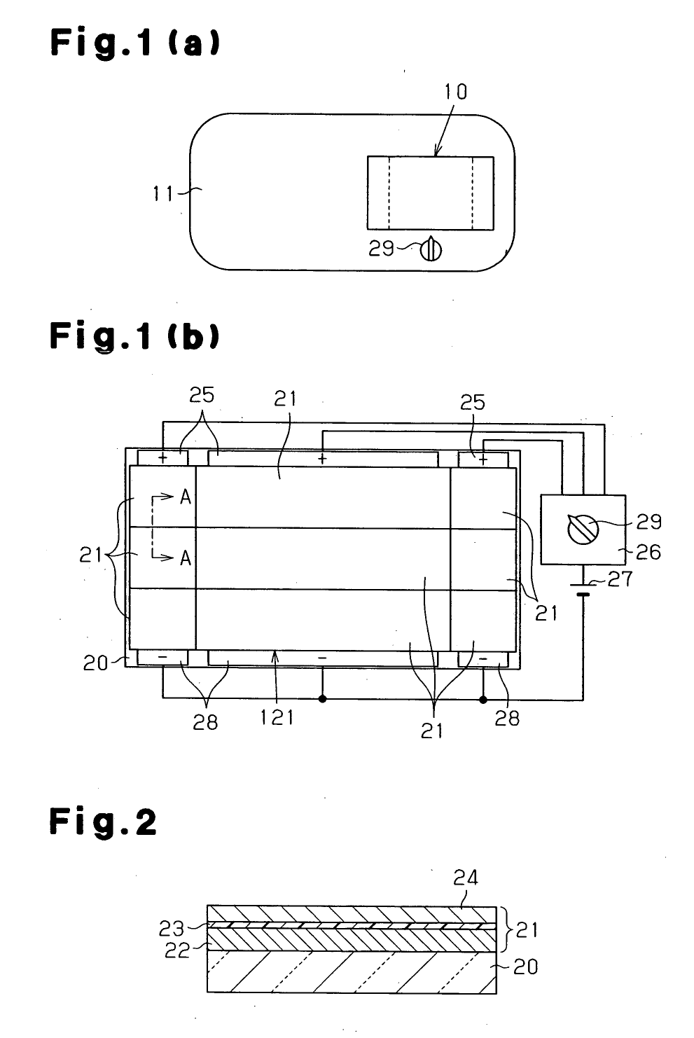

A first embodiment of the present invention will now be described with reference to FIGS. 1(a), 1(b), 2, and 3.

As shown in FIG. 1(a), a mirror with lighting system is applied to a vanity mirror 10 attached to a sunvisor 11 of an automobile. The vanity mirror 10 is a mirror located on the rear side of the sunvisor 11. The vanity mirror 10 is smaller than the sunvisor 11. A light emission switching device, which is a switch 29 in the first embodiment, is formed below the vanity mirror 10 on the sunvisor 11.

The vanity mirror 10 will now be described below. As shown in FIG. 1(b), the vanity mirror 10 includes a transparent substrate 20 and an organic electroluminescent (EL) device 121, which is formed on the transparent substrate 20. The organic EL device 121 includes a plurality of organic EL elements 21, which are arranged adjacent to one another. As shown in FIG. 2, each organic EL element 21 is basically formed by laminating a first electrode portion 22, an organic EL layer portion 23, and a second electrode portion 24 on the transparent substrate 20. Each organic EL element 21 is coated by a protective film, which is not shown, so that the organic EL layer portion 23 is not exposed to the ambient air. Each organic EL element 21 is so called bottom emission type and emission from the organic EL layer portion 23 is output from the transparent substrate 20.

The first electrode portion 22, which is formed on the side (light incident side) of the organic EL layer portion 23 facing the transparent substrate 20, has light transmittance. The second electrode portion 24, which is formed on the side of the organic EL layer portion 23 opposite to the transparent substrate 20, has light reflectivity. Therefore, the second electrode portion 24 serves as a mirror.

The first electrode portion 22 is formed of transparent conductive material. In the first embodiment, indium tin oxide (ITO) is used as the transparent conductive material.

As for the organic EL layer portion 23, a known structure is employed. For example, the organic EL layer portion 23 includes, in order from the first electrode portion 22, three layers of a hole injection layer, an emitting layer, and an electron injection layer, or four layers of a hole injection layer, a hole transport layer, an emitting layer, and an electron transport layer. The organic EL layer portion 23 is designed to emit white light.

The second electrode portion 24 functions as a light reflective surface of the mirror and an electrode for applying voltage to the organic EL layer portion 23. The second electrode portion 24 is made of metal having light reflectivity, such as aluminum (including aluminum alloy) and silver (including silver alloy).

The protective film covers the first electrode portion 22, the organic EL layer portion 23, and the second electrode portion 24 except the surfaces that are adjacent to one another. The protective film is made of material that suppresses transmission of at least moisture (vapor) and oxygen. For example, the protective film is made of silicon dioxide, silicon nitride, or polysilazane.

As shown in FIG. 1(b), in the first embodiment, the transparent substrate 20 is rectangular. Nine organic EL elements 21 are located on the transparent substrate 20 and are arranged in three rows and three columns. The organic EL elements 21 located along the rim of the left and right sides of the transparent substrate 20 as shown in FIG. 1(b) have the same size and the same shape. Three organic EL elements 21 located at the center has the width (length in the left and right direction of FIG. 1(b)) that is longer (in this embodiment, four times longer) than that of the organic EL elements 21 located at the rim of the left and right sides of the transparent substrate 20. Three organic EL elements 21 arranged in each column are electrically connected in series.

The organic EL elements 21 are operated by a battery 27, which is a power source for accessories of the automobile. The organic EL elements 21 that emit light simultaneously and are arranged in the same column are electrically connected in series. In the first embodiment, a positive terminal 25 of each set of three organic EL elements 21 arranged in a column is connected to a positive terminal of the power source, which is the battery 27 in the first embodiment, via a switch box 26. A negative terminal 28 of each set of three organic EL elements 21 is connected to a negative terminal of the battery 27.

The switch box 26 includes the light emission switching device, which is the switch 29 in the first embodiment, for selecting which of the three sets of the organic EL elements 21 is switched to a light emission state or a non-light emission state. The switch box 26 and the switch 29 are located on the sunvisor 11. The switch 29 is designed to selectively switch between an OFF position at which all the organic EL elements 21 on the transparent substrate 20 are brought into the non-light emission state and an ON position at which the selected organic EL elements 21 are brought into the light emission state.

The ON position includes three positions: a first stage (a first partial light emission state) at which the organic EL elements 21 located on the left and right sides are brought into the light emission state; a second stage (a second partial light emission state) at which the organic EL elements 21 located at the center are brought into the light emission state; and a third stage at which all the organic EL elements 21 on the transparent substrate 20 are brought into the light emission state.

The switch box 26 and the switch 29 constitute a light emission switching device for selecting a full light emission state where all the organic EL elements 21 emit light, a partial light emission state where part of the organic EL elements 21 emit light, and a non-light emission state where all the organic EL elements 21 do not emit light. In other words, the switch box 26 and the switch 29 constitute a light emission switching device for selecting a full light emission state where the organic EL layer portions 23 corresponding to all the first electrode portions 22 and the second electrode portions 24 emit light, a partial light emission state where the organic EL layer portions 23 corresponding to some of the first electrode portions 22 and the second electrode portions 24 emit light, and a non-light emission state where all the organic EL layer portions 23 do not emit light.

Each second electrode portion 24 includes a light reflective portion. Part of the light reflective portion corresponding to the organic EL layer portions 23 that are in the non-light emission state functions as a mirror. That is, each organic EL element 21 (organic EL device 121) includes the light reflective portion. When the non-light emission state is selected, all the second electrode portions 24 function as a mirror.

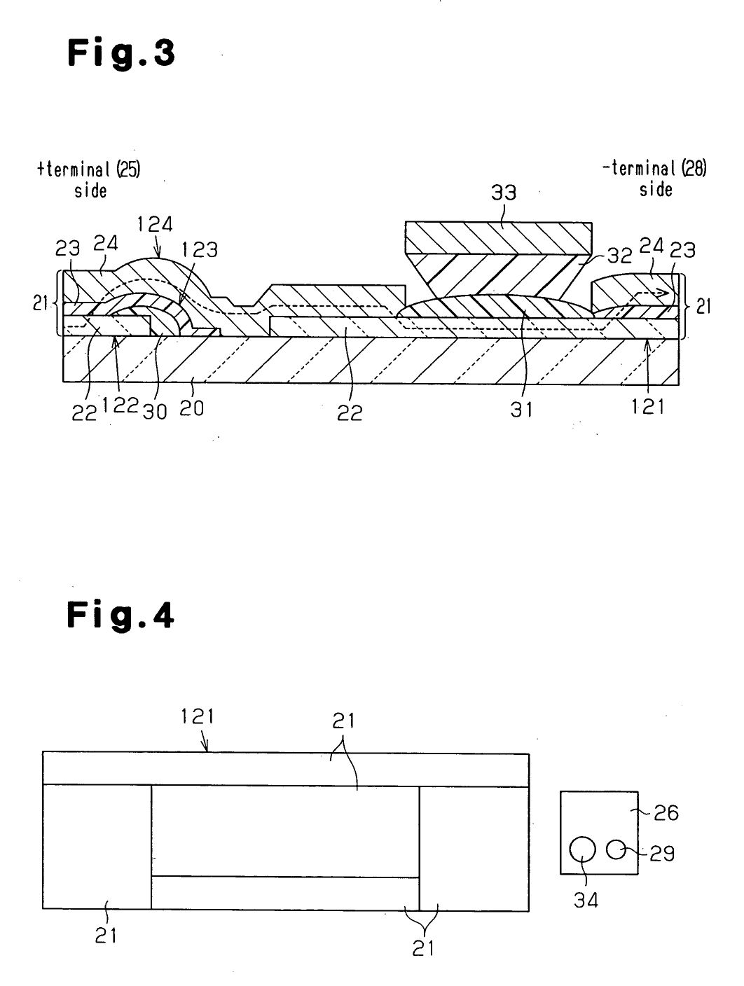

The structure of a part where the organic EL elements 21 are electrically connected in series will now be described. As shown in FIG. 3, one of the two adjacent organic EL elements 21, which is located closer to the positive terminal 25 (the left organic EL element 21 in FIG. 3), is covered with a transparent insulating layer 30 at the end of the first electrode portion 22 facing the negative terminal 28 (right in FIG. 3). The organic EL layer portion 23 is formed on the first electrode portion 22 to cover the transparent insulating layer 30. The transparent insulating layer 30 prevents leakage between the first electrode portion 22 of the organic EL element 21 located closer to the positive terminal 25 and the second electrode portion 24.

One of the two adjacent organic EL elements 21, which is located closer to the negative terminal 28 (the right organic EL element 21 in FIG. 3), has a part of the first electrode portion 22 toward the positive terminal 25. On the part of the first electrode portion 22, a transparent insulating layer 31 is formed. A partition 32 is formed on the transparent insulating layer 31. An organic EL layer portion 23 covers the first electrode portion 22 at a part toward the negative terminal 28 from the transparent insulating layer 31. That is, the first electrode portion 22 of the organic EL element 21 located closer to the negative terminal 28 has a part not covered with the organic EL layer portion 23 at the end closer to the positive terminal 25.

The second electrode portion 24 of the organic EL element 21 located closer to the positive terminal 25 extends to the end of the transparent insulating layer 31 facing the positive terminal 25 located on the first electrode portion 22 of the organic EL element 21 located closer to the negative terminal 28. That is, the second electrode portion 24 of the organic EL element 21 located closer to the positive terminal 25 is directly connected to the first electrode portion 22 of the organic EL element 21 located closer to the negative terminal 28.

The second electrode portion 24 of the organic EL element 21 located closer to the negative terminal 28 is formed on the organic EL layer portion 23 of the organic EL element 21. A reflective layer 33 made of material that is the same as the second electrode portion 24 is formed on the partition 32.

As shown in FIG. 3, a first electrode 122 has the first electrode portions 22, which are discontinuous with one another. An organic EL layer 123 has the organic EL layer portions 23, which are discontinuous with one another A second electrode 124 has the second electrode portions 24, which are discontinuous with one another. The first electrode 122, the organic EL layer 123, and the second electrode 124 are laminated on the transparent substrate 20.

The second electrode portions 24 and the reflective layer 33 of the organic EL elements 21 are formed simultaneously by deposition. Therefore, the partition 32 reliably prevents the second electrode portions 24 from being continuous between the adjacent organic EL elements 21. The partition 32 is tapered such that the width at the end close to the transparent substrate 20 is the narrowest and the width at the distal end is the broadest. In the first embodiment, the transparent insulating layers 30, 31 and the partition 32 are formed in photoresist.

FIG. 3 is a schematic view of each part. In fact, the thickness of the transparent substrate 20 (for example, a glass plate) is approximately 0.3 mm to 2 mm, and the thickness of the first electrode portion 22, the organic EL layer portion 23, and the second electrode portion 24 are approximately some tens to a thousand nm. The thickness of the transparent insulating layers 30, 31 is greater than or equal to the thickness of the first electrode portion 22. The partition 32 is sufficiently thicker than the first electrode portion 22, the organic EL layer portion 23, the second electrode portion 24, and the transparent insulating layers 30, 31.

The operation of the vanity mirror 10 formed as described above will now be described with reference to FIGS. 1 and 3.

As shown in FIG. 1(a), the appearance of the vanity mirror 10 is almost the same as that of a vanity mirror without a lighting system. When the switch 29 is off, the entire surface of the vanity mirror 10 is used as the mirror at a bright place. Turning the switch 29 by one stage causes the partial light emission, and the organic EL elements 21 arranged along the rims of the left and right sides of the transparent substrate 20 emit light (first partial light emission state). In this case, the vanity mirror 10 can be used as the mirror with the lighting system and the lighting system.

When the switch 29 is further turned by one stage, the organic EL elements 21 located at the center and electrically connected in series are switched into the light emission state (second partial light emission state), and the vanity mirror 10 can be used as the lighting system. When the switch 29 is further turned by one stage, all the organic EL elements 21 on the transparent substrate 20 are switched into the light emission state and the full light emission is performed. Thus, the vanity mirror 10 can be used as the lighting system in the brightest state.

For example, to use the vanity mirror 10 as a mirror in the dark without using a room light of the automobile, only the opposing rims of the vanity mirror 10 are lighted up and the portion that is not lighted up is used as a mirror. At this time, the non-light emitting portion used as a mirror functions as a single mirror. When using the mirror with lighting system as the lighting system, the partial light emission and the full light emission can be selected by turning the switch 29 in accordance with the necessary light intensity.

At a portion where adjacent organic EL elements 21 are electrically connected in series, current flows from the first electrode portion 22 close to the positive terminal 25 to the second electrode portion 24 through the organic EL layer portion 23 as shown by an arrow drawn by a broken line in FIG. 3. Current flows from the end (close to the negative terminal 28) of the second electrode portion 24 to the first electrode portion 22 of the adjacent organic EL element 21. As a result, current supplied to the positive terminal 25 of each set of three organic EL elements 21 flows to the negative terminal of the battery 27 through the negative terminal 28.

In the first embodiment, the battery 27 is used as the power source. Since three organic EL elements 21 are electrically connected in series, each organic EL element 21 receives voltage of substantially one third of the battery 27. The battery 27 of the automobile has the voltage of 12 V. Therefore, if the organic EL elements 21 are electrically connected in parallel, voltage of 12 V is applied to each organic EL element 21, which is too high and undesirable. However, since three organic EL elements 21 are electrically connected in series, voltage applied to each organic EL element 21 is approximately 4 V. This is greater than or equal to the minimum voltage required to light up the organic EL element 21. Since the organic EL elements 21 are connected in series and the amount of current flowing through each organic EL element 21 is substantially the same, the light intensity of each organic EL element 21 is substantially the same.

The advantages of the first embodiment will now be described.

(1) The full light emission state in which the entire light emitting portion constituted by the organic EL elements 21 emits light so that the entire surface of the transparent substrate 20 emits light, and the partial light emission state in which part of the light emitting portion emits light can be selected. Therefore, when the mirror with lighting system is used as the lighting system, different brightness is achieved by selecting the partial light emission state or the full light emission state. When using the mirror with lighting system as a mirror in the dark without using other lighting system such as a fluorescent light, part of the light emitting portion is lighted up and the other part that is not lighted up is used as a mirror. When the environment is bright, the entire surface of the light emitting portion can be used as a mirror.

(2) The organic EL elements 21 are arranged in a substantially rectangular shape and some of the organic EL elements 21 are arranged along the opposing (left and right) rims. Therefore, when the peripheral portion is used as the lighting system, shade of the face is prevented from being reflected in the mirror since the light is emitted from both sides of the mirror.

(3) When the user selects the partial light emission, the user can select the light emission state in which the non-light emitting portion functions as a single mirror. That is, the organic EL elements 21 that do not emit light in the first partial light emission state are arranged adjacent to one another. Therefore, when the mirror with lighting system is used as a mirror in the dark without using other lighting system, only one mirror portion is provided. Therefore, as compared to a case where several separate mirrors are provided, the mirror with lighting system according to the first embodiment is convenient.

(4) Since the organic EL layer portion 23 is designed to emit white light, colors of the surrounding objects are easily recognized as compared to a case where other color is emitted.

(5) The partition 32 is formed thicker than the second electrode portion 24. Therefore, when simultaneously forming the second electrode portion 24 and the reflective layer 33 in deposition, the second electrode portion 24 is reliably prevented from being continuous between the adjacent organic EL elements 21.

(6) The mirror with lighting system is applied to the vanity mirror 10 attached to the sunvisor 11 of the automobile. Therefore, the vanity mirror 10 has the advantages that are the same as the advantages (1) to (5).

(7) Three organic EL elements 21 are electrically connected in series and use the battery 27 for the accessories of the automobile as the power source. Therefore, when using the battery 27 of the automobile having the voltage of 12 V, the voltage applied to each organic EL element 21 becomes 4 V. Therefore, a resistance need not be connected to lower the voltage. Since the amount of current flowing through each organic EL element 21 is the same, the light intensity is substantially the same.

A second embodiment of the present invention will now be described with reference to FIG. 4. The second embodiment differs from the first embodiment in that when the mirror with lighting system is used as a lighting system, the brightness can be adjusted in multiple stages or continuously. Like or the same reference numerals are given to those components that are like or the same as the corresponding components of the first embodiment and detailed explanations are omitted.

As shown in FIG. 4, the vanity mirror 10 is divided into five luminous areas. The organic EL elements 21 are electrically connected in parallel. The switch 29, the switch box 26, and an applied voltage changing member, which is a volume 34, are located on the sunvisor 11. The switch 29 is used to select whether to switch each of the organic EL element 21 into the light emission state or the non-light emission state.

The volume 34 is designed to adjust the voltage applied to each organic EL element 21 and adjusts the intensity of light emitted from each organic EL element 21. In the second embodiment, a variable resistor is used, and the resistance is changed by manipulating the volume 34 to adjust the voltage applied to each organic EL element 21.

The second embodiment has the following advantages in addition to the advantages (1) to (4), (6), and (7) of the first embodiment.

(8) The vanity mirror 10 includes the applied voltage changing member, which is the volume 34. Therefore, the intensity of the light emitted from the organic EL layer portion 23 can be adjusted to achieve a desired brightness by manipulating the volume 34.

(9) The luminous area is divided into five areas, and each area is selectively switched to the light emission state or the non-light emission state independently. Therefore, all the organic EL elements 21 may be switched to the light emission state or an arbitrary organic EL element 21 may be switched to the light emission state. Further, the intensity of the light can be adjusted in multiple stages or continuously.

(10) By selecting the organic EL element 21 to be switched to the light emission state and manipulating the volume 34, a desired brightness can be selected.

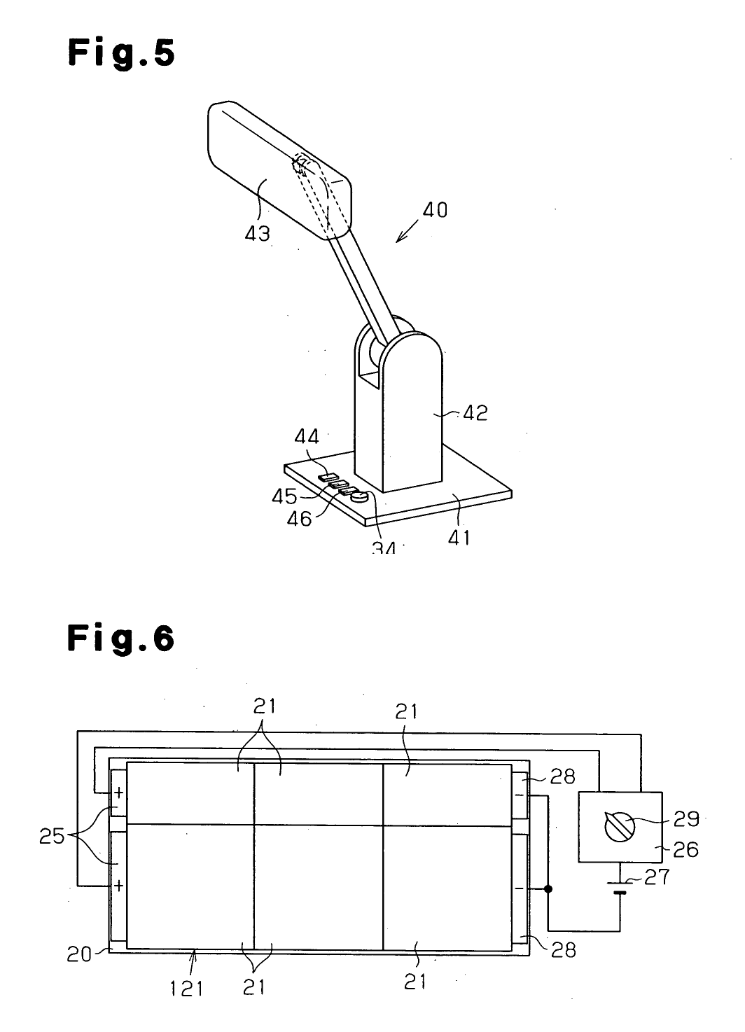

A third embodiment of the present invention will now be described with reference to FIG. 5. The third embodiment differs from the first embodiment in that the mirror with the lighting system is used as a desk light 40.

As shown in FIG. 5, the desk light 40 equipped with a mirror with lighting system includes a square box-like base 41, a columnar support 42 located on the base 41, and a mirror with lighting system 43.

The base 41 includes switches 44, 45, and 46 of the mirror with lighting system 43 and the applied voltage changing member, which is the volume 34 in the third embodiment. The switches 44, 45, and 46 are for selecting whether to switch the light emitting portion of the mirror 43 that can independently emit light into the light emission state or the non-light emission state. The base 41 houses an AC-DC inverter, which is not shown. The AC-DC inverter converts alternative current for household appliances into direct current and supplies the DC voltage to the organic EL elements 21.

The columnar support 42 supports the mirror with lighting system 43. In the third embodiment, the columnar support 42 is rotatable at the middle portion.

When the switches 44, 45, and 46 are off, the entire surface of the mirror with lighting system 43 is in the non-light emission state. When the switch 44 is switched on, the opposing rims of the left and rihgt of the mirror with lighting system 43 are switched to the light emission state and other organic EL elements 21 are in the non-light emission state. When the switch 45 is switched on, the organic EL elements 21 located at the center electrically connected in series are switched to the light emission state and the left and right peripheral portions of the mirror with lighting system 43 are in the non-light emission state. When the switch 46 is switched on, the entire surface of the mirror with lighting system 43 is switched to the light emission state.

The third embodiment has the following advantages in addition to the advantages (1) to (5) of the first embodiment, and (8) and (10) of the second embodiment.

(11) The mirror with lighting system is provided in the desk light 40. Therefore, the mirror with lighting system can be located at the bedside and used as a reading light. When the environment is bright, the mirror with lighting system 43 is used as a normal mirror and when it is dark, the switch 44 is switched ON to light up the organic EL elements 21 located along the opposing rims of the left and rihgt of the mirror with lighting system 43. Therefore, the non-light emitting portion can be used as a mirror.

A fourth embodiment of the present invention will now be described with reference to FIG. 6. The fourth embodiment differs from the first embodiment in that the organic EL elements 21 are arranged along the rims of the longitudinal sides of the transparent substrate 20.

As shown in FIG. 6, in the fourth embodiment, the transparent substrate 20 is rectangular. Six organic EL elements 21 are located on the transparent substrate 20 and are arranged in two rows and three columns. Three organic EL elements 21 arranged along the upper rim of the transparent substrate 20 shown in FIG. 6 have the same size and the same shape. Three organic EL elements 21 arranged along the lower rim of the transparent substrate 20 have the length (the vertical length as shown in FIG. 6) that is longer (twice longer in the fourth embodiment) than the length of the organic EL elements 21 located along the upper rim of the transparent substrate 20. Three organic EL elements 21 arranged side by side in each row are electrically connected in series.

The fourth embodiment has the following advantages in addition to the advantages (1) and (3) to (7) of the first embodiment.

(12) The organic EL elements 21 are substantially rectangular and are arranged along at least one of the longitudinal rims of the transparent substrate 20. Therefore, when the mirror with lighting system is used as the mirror, shade of the face is prevented from being reflected in the mirror since the light is emitted from the longitudinal rim.

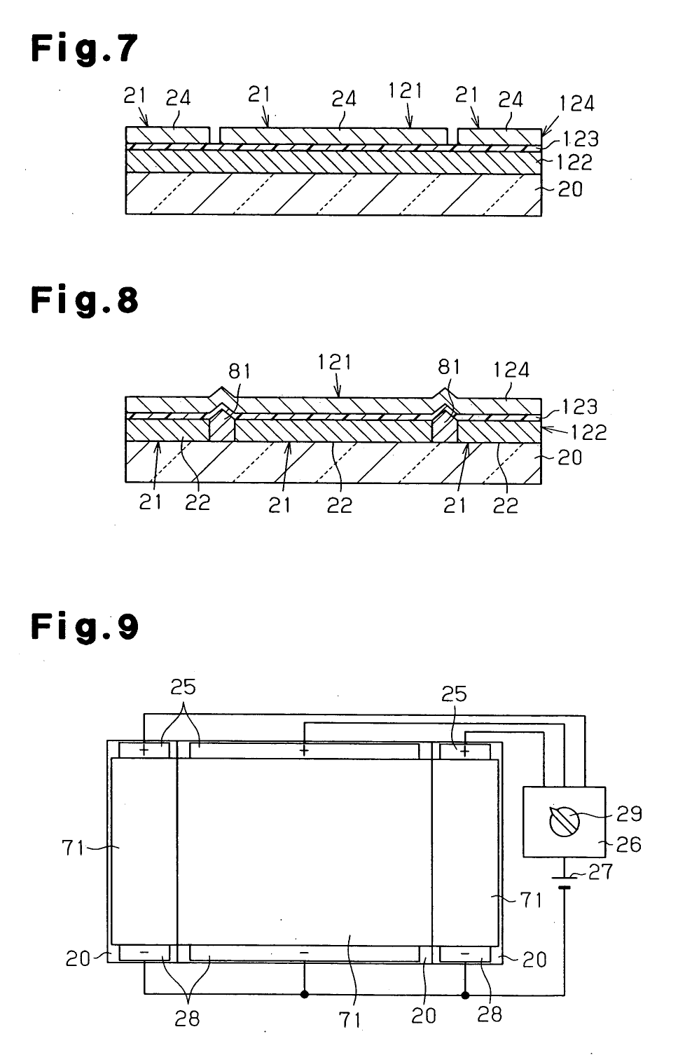

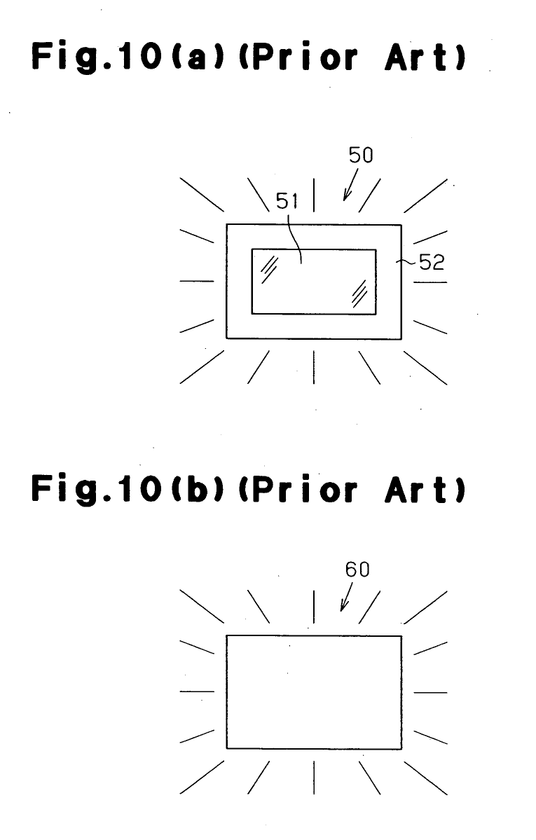

A fifth embodiment of the present invention will now be described with reference to FIG. 7. According to the fifth embodiment, the first electrode 122, the organic EL layer 123, and the second electrode 124 are formed on the transparent substrate 20. The fifth embodiment differs from the first embodiment in that only the second electrode 124 is discontinuous, and the first electrode 122 and the organic EL layer 123 are continuous. The second electrode 124 is discontinuous along the left and right rims of the transparent substrate 20. That is, the second electrode 124 has the second electrode portions 24, which are discontinuous with one another.

The fifth embodiment has the same advantages as the advantages (1) to (4) of the first embodiment.

A sixth embodiment of the present invention will now be described with reference to FIG. 8. According to the sixth embodiment, the first electrode 122, the organic EL layer 123, and the second electrode 124 are formed on the transparent substrate 20, and the sixth embodiment differs from the first embodiment in that only the first electrode 122 is discontinuous, and the organic EL layer 123 and the second electrode 124 are continuous.

The first electrode 122 is discontinuous along the left and right rims of the transparent substrate 20. That is, the first electrode 122 has the first electrode portions 22, which are discontinuous with one another. A transparent insulation material 81 is put in a portion where the first electrode 122 is discontinuous. For example, the transparent insulation material 81 is formed of photoresist.

In the sixth embodiment, the first electrode 122 is thicker than the organic EL layer 123.

The sixth embodiment has the same advantages as the advantages (1) to (4) of the first embodiment.

A seventh embodiment of the present invention will now be described with reference to FIG. 9. The seventh embodiment differs from the first embodiment in that several (in this embodiment, three) panels 71 are provided. Each panel 71 is equipped with a first electrode 122, an organic EL layer 123 and a second electrode 124 located on a transparent substrate 20. The panels 71 are arranged such that the end faces of the transparent substrate 20 of the adjacent panels 71 face one another.

The seventh embodiment uses an adhesive that has no optical absorption when the adjacent panels 71 are adhered to each other and becomes clouded when solidified. For example, an adhesive that includes air bubbles in an adhesive layer is used.

The seventh embodiment has the same advantages as the advantages (2) to (4) of the first embodiment. In addition, the seventh embodiment has the following advantages.

(13) Since several panels 71 are adhered to one another, the mirror with lighting system is made having an area larger than that of a mirror having single panel 71.

(14) Since the panels 71 are adhered to one another with an adhesive that becomes clouded when solidified, the joint portion does not become dark and conspicuous by scattering of light during emission.

(15) A large size mirror with lighting system is easily formed by combining the panels 71.

(16) Since a large size mirror with lighting system can be made by using several panels 71, the yield is improved as compared to a case where a mirror with lighting system of the same size is made of one organic EL element.

The invention may be embodied in the following forms.

In the first embodiment, the vanity mirror 10 may be detachable to the sunvisor 11 of the automobile. When the vanity mirror 10 is attached to the sunvisor 11, the vanity mirror 10 receives power from the battery 27 of the automobile. When the vanity mirror 10 is detached from the sunvisor 11, a wire extends to supply power from the battery 27. In this case, the vanity mirror 10 can be detached from the sunvisor 11 to light a place that cannot be directly lighted from the position where the sunvisor 11 is installed.

The switch 29 for lighting up the vanity mirror 10 and the applied voltage changing member, which is the volume 34, may be located at a position other than on the sunvisor 11. For example, the switch 29 and the volume 34 may be located on an instrument panel.

With the structure in which the vanity mirror 10 is detachable, the switch 29 and the volume 34 may be located on the vanity mirror 10, and the vanity mirror 10 may be equipped with a battery. In this case, when the vanity mirror 10 is detached from the sunvisor 11, the vanity mirror 10 receives power from another battery. When the vanity mirror 10 is attached to the sunvisor 11, the another battery is supplied with power from the battery 27 of the automobile and is charged.

The mirror with lighting system is not restricted to the mirror with lighting system 43 attached to the vanity mirror 10 or the desk light 40 but may be applied to other mirrors. The mirror with lighting system may either be portable or stationary. For example, the mirror with lighting system may be applied to a hand mirror, which is a cosmetic mirror, a portable foldable mirror, or a portable mirror for portable goods (lint brush).

In the first, second, and third embodiments, the number of the organic EL elements 21 defined adjacent to one another on the transparent substrate 20 is five, six, or nine, but may be any number greater than or equal to two.

In the first embodiment, the left and right rims of the vanity mirror 10 are lighted up when the environment is dark. However, when the mirror is longer than is wide, the light emitting portion at the upper and lower rims may be lighted up in the dark.

In the fourth embodiment, the upper side of the mirror in FIG. 6 may be lighted up and the lower side of the mirror may be selected to be the non-light emitting portion, which is used as a mirror. The lower side of the mirror may be lighted up and the upper side of the mirror may be selected to be the non-light emitting portion, which is used as a mirror.

In the fifth and sixth embodiments (FIGS. 7 and 8), only the second electrode 124 or the first electrode 122 are partially discontinuous. However, all the first electrode 122, the organic EL layer 123, and the second electrode 124 may be formed to be discontinuous. Alternatively, the first electrode 122 and the organic EL layer 123 may be formed to be discontinuous or the second electrode 124 and the organic EL layer 123 may be formed to be discontinuous. In this case, the first electrode 122 and the second electrode 124 are formed not to cause an electrical short.

In the sixth embodiment (FIG. 8), the transparent insulation material 81 is formed thicker than the first electrode portion 22. The transparent insulation material 81 may have any thickness as long as the organic EL layer 123 can be formed without a cut.

In the sixth embodiment, the transparent insulation material 81 is filled in the gap between the first electrode portions 22. However, if the first electrode 122 is significantly thinner than the organic EL layer 123, the organic EL layer 123 can be formed without a cut in the state where the gap is not previously filled. Therefore, the transparent insulation material 81 need not be formed.

In the seventh embodiment (FIG. 9), the vanity mirror 10 is formed of three panels 71. However, the mirror with lighting system may be formed of any number of panels 71 other than three as long as there are two or more panels 71.

In the seventh embodiment, the panels 71 are adhered to one another with an adhesive that becomes clouded when solidified. However, the end faces of the transparent substrate 20 of each panel 71 may be roughened or a gel-like body that scatters light may be put between the transparent substrates 20 of the adjacent panels 71.

In the seventh embodiment, the panels 71 are adhered to one another with an adhesive that becomes clouded when solidified. However, an adhesive may be used that does not become clouded when solidified or does not scatter light.

In the seventh embodiment, the adhesive need not include air bubbles to scatter light as long as the adhesive reflects or refracts light. For example, ceramics or metal powder may be included in the adhesive.

The shape of the mirror with lighting system may be a square or other quadrangle, a triangle, a polygon with more sides than or equal to a pentagon, a circular shape, an ellipse, or an arbitrary shape.

The light emitted from the organic EL layer portion 23 need not be white but the mirror with lighting system may be elaborately designed using blue or read light. In this case, the mirror is not used for reflecting the user's face or figure but is suitable for display.

The entire light emitting portion need not emit the same color. However, the mirror with lighting system may be elaborately designed to partially emit different colors of light (for example, blue and red).

The organic EL layer portion 23 may have a single-layered structure having only an emitting layer, or a multi-layered structure in which one or more of a hole injection layer, a hole transport layer, a hole injection transport layer, a hole blocking layer, an electron injection layer, an electron transport layer, and an electron blocking layer and an emitting layer are laminated.

The second electrode portion 24 and the reflective layer 33 need not be formed of metal having light reflectivity but may be formed of transparent conductive material. Instead, a layer having light reflectivity may be formed on the surface of the second electrode portion 24 and the reflective layer 33 opposite to the organic EL layer portion 23. That is, a layer having light reflectivity (light reflective portion) is located opposite to the transparent substrate 20 with respect to the organic EL elements 21. In other words, the light reflective portion is located opposite to the transparent substrate 20 with respect to the second electrode portions 24. In this case, the layer having light reflectivity serves as a mirror.

The transparent substrate 20 need not be a glass as long as the substrate 20 is transparent. For example, the transparent substrate 20 may be formed of resin.

The present examples and embodiments are to be considered as illustrative and not restrictive and the invention is not to be limited to the details given herein, but may be modified within the scope and equivalence of the appended claims.

1. A mirror with lighting system, the mirror comprising:
a transparent substrate;
an organic electroluminescent device formed on the transparent substrate, the organic electroluminescent device including a plurality of organic electroluminescent elements arranged adjacent to one another;
a light emission switching device for selecting one of a full light emission state where all the organic electroluminescent elements emit light, a partial light emission state where some of the organic electroluminescent elements emit light, and a non-light emission state where all the organic electroluminescent elements do not emit light; and
a light reflective portion, wherein the entire surface of the light reflective portion functions as a mirror when the non-light emission state is selected.

2. The mirror according to claim 1, wherein the organic electroluminescent device includes the light reflective portion.

3. The mirror according to claim 1, wherein the light reflective portion is located opposite to the transparent substrate with respect to the organic electroluminescent device.

4. The mirror according to claim 1, wherein part of the light reflective portion corresponding to the organic electroluminescent elements that do not emit light functions as a mirror, and the organic electroluminescent elements that do not emit light in the partial light emission state are located adjacent to one another.

5. The mirror according to claim 1, wherein the plurality of organic electroluminescent elements are arranged to form a substantially rectangular shape as a whole, and at least some of the organic electroluminescent elements are arranged along the opposing rims of the transparent substrate.

6. The mirror according to claim 1, wherein the plurality of organic electroluminescent elements are arranged to form a substantially rectangular shape as a whole, and at least some of the organic electroluminescent elements are arranged along one of the rims, which extend in a longitudinal direction of the transparent substrate.

7. The mirror according to claim 1, further comprising an applied voltage changing member, which changes the voltage applied to the organic electroluminescent elements.

8. The mirror according to claim 1, wherein the mirror is a vanity mirror located on a sunvisor of an automobile.

9. The mirror according to claim 8, wherein the mirror is attached to the sunvisor of the automobile such that the mirror can be detached.

10. The mirror according to claim 8, wherein the organic electroluminescent elements are supplied with electricity from a power source for accessories of the automobile, and
some of the organic electroluminescent elements, which simultaneously emit light and are arranged in the same column, are electrically connected in series.

11. The mirror according to claim 1, wherein the organic electroluminescent elements emit white light.

12. A mirror with lighting system, the mirror comprising:
a transparent substrate;
a first electrode formed on the transparent substrate;
an organic electroluminescent layer formed on the first electrode;
a second electrode formed on the organic electroluminescent layer, and at least one of the first electrode and the second electrode has a plurality of electrode portions, which are discontinuous;
a light emission switching device for selecting one of a full light emission state where portions of the organic electroluminescent layer corresponding to all the electrode portions emit light, a partial light emission state where portions of the organic electroluminescent layer corresponding to some of the electrode portions emit light, and a non-light emission state where the entire organic electroluminescent layer does not emit light; and
a light reflective portion, wherein the entire surface of the light reflective portion functions as a mirror when the non-light emission state is selected.

13. The mirror according to claim 12, wherein the second electrode includes the light reflective portion.

14. The mirror according to claim 12, wherein the light reflective portion is located opposite to the transparent substrate with respect to the second electrode.

15. The mirror according to claim 12, wherein the organic electroluminescent layer has a plurality of organic electroluminescent layer portions, which are discontinuous.

16. The mirror according to claim 12, wherein the first electrode and the second electrode each have the plurality of electrode portions, which are discontinuous.

17. The mirror according to claim 12, wherein parts of the light reflective portion corresponding to portions of the organic electroluminescent layer that do not emit light in the partial light emission state function as a mirror and are located adjacent to one another.

18. The mirror according to claim 12, wherein the plurality of electrode portions are arranged to form a substantially rectangular shape as a whole, and at least some of the electrode portions are arranged along the opposing rims of the transparent substrate.

19. The mirror according to claim 12, wherein the plurality of electrode portions are arranged to form a substantially rectangular shape as a whole, and at least some of the electrode portions are arranged along one of the rims, which extend in a longitudinal direction of the transparent substrate.

20. The mirror according to claim 12, wherein the mirror is a vanity mirror located on a sunvisor of an automobile.

21. The mirror according to claim 20, wherein the first electrode and the second electrode are supplied with electricity from a power source for accessories of the automobile, and
some of the electrode portions, which simultaneously emit light and are arranged in the same column, are electrically connected in series.

22. A mirror with lighting system, the mirror comprising:
a plurality of panels, each panel including a transparent substrate and an organic electroluminescent device located on the transparent substrate, and the panels are arranged such that the end faces of the transparent substrates face one another;
a light emission switching device for selecting one of a full light emission state where all the organic electroluminescent devices emit light, a partial light emission state where some of the organic electroluminescent devices emit light, and a non-light emission state where all the organic electroluminescent devices do not emit light; and
a light reflective portion, wherein the entire surface of the light reflective portion functions as a mirror when the non-light emission state is selected.

23. A sunvisor of an automobile having a vanity mirror, the vanity mirror comprising:
a transparent substrate;
an organic electroluminescent device formed on the transparent substrate, the organic electroluminescent device including a plurality of organic electroluminescent elements arranged adjacent to one another;
a light emission switching device for selecting one of a full light emission state where all the organic electroluminescent elements emit light, a partial light emission state where some of the organic electroluminescent elements emit light, and a non-light emission state where all the organic electroluminescent elements do not emit light; and
a light reflective portion, wherein the entire surface of the light reflective portion functions as a mirror when the non-light emission state is selected.
